(19) United States
(12) Patent Application Publication
(10) Pub. No.: US 2002/0073410 A1
(43) Pub. Date: Jun. 13, 2002

(54) Replacing software at a telecommunications platform

(76) Inventors: Arne Lundback, Skogas (SE); Rolf Eriksson, Stockholm (SE); Staffan Larsson, Tyreso (SE); Mats Nilsson, Stockholm (SE)

Correspondence Address: NIXON & VANDERHYE P.C., 8th Floor, 1100 North Glebe Road, Arlington, VA, 22201-4714, US

(21) Appl. No.: 09/734,948

(22) Filed: Dec. 13, 2000

(51) Int. Cl. G06F 9/445

(52) U.S. Cl. 717/171; 717/172; 709/221

(57) ABSTRACT

Software in the form of a program (60) is replaced (e.g., upgraded) on a telecommunications platform (node) (620, 20) without shutting down the telecommunications functions of the platform. The old program (60_{1.0}) that is replaced is of a type which stores state information in a state storage system (200). In connection with a software (program) replacement operation for the old program, after a new program (60_{1.1}) is started either a shutdown (2-4) instruction is sent to the old program, a software support function of the platform activates a conversion program (80). The conversion program renders the state information of the old program as converted state information which is usable by the new program.

This application is related to U.S. patent application Ser. No. 09/467,018 filed Dec. 20, 1999, entitled “Internet Protocol Handler for Telecommunications Platform With Processor Cluster”, as well as to the following simultaneously-filed United States Patent Applications: U.S. patent application Ser. No. 09/______ , ______ (attorney docket: 2380-182), entitled “Telecommunications Platform With Processor Cluster and Method of Operation Thereof”; and U.S. patent application Ser. No. 09/______, (attorney docket: 2380-180), entitled “Software Distribution At A Multi-Processor Telecommunications Platform”, all of which are incorporated herein by reference.

### BACKGROUND

1. Field of the Invention

The present invention pertains to platforms of a telecommunications system, and particularly to such platforms having a multi-processor configuration.

2. Related Art and Other Consideration

Software replacements, such as upgrades, are typically attempted by various techniques. One technique is to provide a passive standby processor which takes over all software tasks from another (active) processor while the software on the another (active) processor is being upgraded. When the upgrade activities are finished, the tasks are transferred back to the upgraded processor and the standby processor possibly undergoes actions in preparation for further task take over from the upgraded processor. The standby processor can be in either a hot or cold standby mode in accordance with how long it takes the standby processor to take over tasks from another processor. If the overall system has many active processors having software which may require upgrading, there is a trade off between the number of standby processors which can be used and the length of time required to implement fully the upgrade across the entire system. In any event, a system of standby processors implies unused execution resources. None of the standby processors typically perform any useful work, even thought they may be running (at least in the hot standby case)

Another technique is to provide a pair of completely synchronized processors which perform the same tasks simultaneously, but with the result of the task being utilized from only one of the processors. Thus, in accordance with this synchronized technique, the two involved processors both execute the same instructions at the same time. In the case of software upgrade for one of the pair of processors, the result from the non-upgrading processor is utilized. However, effective synchronization of pairs of processors requires some control or knowledge of processor design, and does not lend itself well to commercially available processors. Moreover, a synchronization system is quite inflexible regarding size and scalability.

What is needed, therefore, and an object of the present invention, is telecommunications platform that provides software upgrade capability without shutting down the entire platform or wasting processing power.

### BRIEF SUMMARY OF THE INVENTION

Software in the form of a program is replaced, e.g., upgraded, on a telecommunications platform (node) without shutting down the telecommunications functions of the platform. The old program that is replaced is of a type which stores state information in a state storage system. In connection with a software (program) replacement operation for an old program, after a new program is started either a shutdown instruction is sent to the old program or the old program is stopped. In either case, after termination of the old program, a software support function of the platform activates a conversion program. The conversion program renders the state information of the old program as converted state information which is usable by the new program.

In some modes of the invention, when the old program is issued a shutdown instruction, a shutdown process is performed by the old program. The shutdown process involves various activities such as unpublishing the old program in a name server; task finalization; storing the state information of the old program; releasing resources and closing files utilized by the old program; and confirming shutdown to the software support function.

Other modes of the invention are particularly useful when plural processors serve as a main processor cluster. In one such of these other modes of the invention, a standby copy of the old program is activated on a second processor of the cluster. The standby copy of the old program is executed until a master copy of the new program is started by restart of the first processor. Upon restart of the first processor, a standby copy of the new program is loaded on the second processor.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a schematic view of a telecommunications platform at which a software replacement operation is to be performed.

FIG. 2 is a schematic view of a telecommunications platform showing various actions involved in a software (program) replacement (e.g., upgrade) operation according to a mode of the present invention.

FIG. 3 is a diagrammatic view of a load module.

FIG. 4 is a diagrammatic view illustrating loading of a load module to create programs in plural processors.

FIG. 5 is a flowchart showing basic actions performed in connection with execution of a shutdown process of a program in accordance with the mode of FIG. 2.

FIG. 6 is a schematic view of a telecommunications platform showing various actions involved in a software (program) replacement operation according to another mode of the present invention.

FIG. 7 is a schematic view of a telecommunications platform having a main processor cluster according to an embodiment of the invention.

FIG. 8 is a schematic view of showing distribution of Cluster Support Function throughout the main processor cluster of FIG. 1.

FIG. 9 is a diagrammatic view showing issuance of various messages from a cluster support function to various load modules in accordance with the present invention.

FIG. 10 is a schematic view of one example embodiment of a ATM switch-based telecommunications platform having the cluster support function of the invention.

FIG. 11 is a diagrammatic view of a name table maintained by a name server system of the cluster support function, showing a correlation of design name and run time reference for programs executed by the main processor cluster of the invention.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well known devices, circuits, and methods are omitted so as not to obscure the description of the present invention with unnecessary detail.

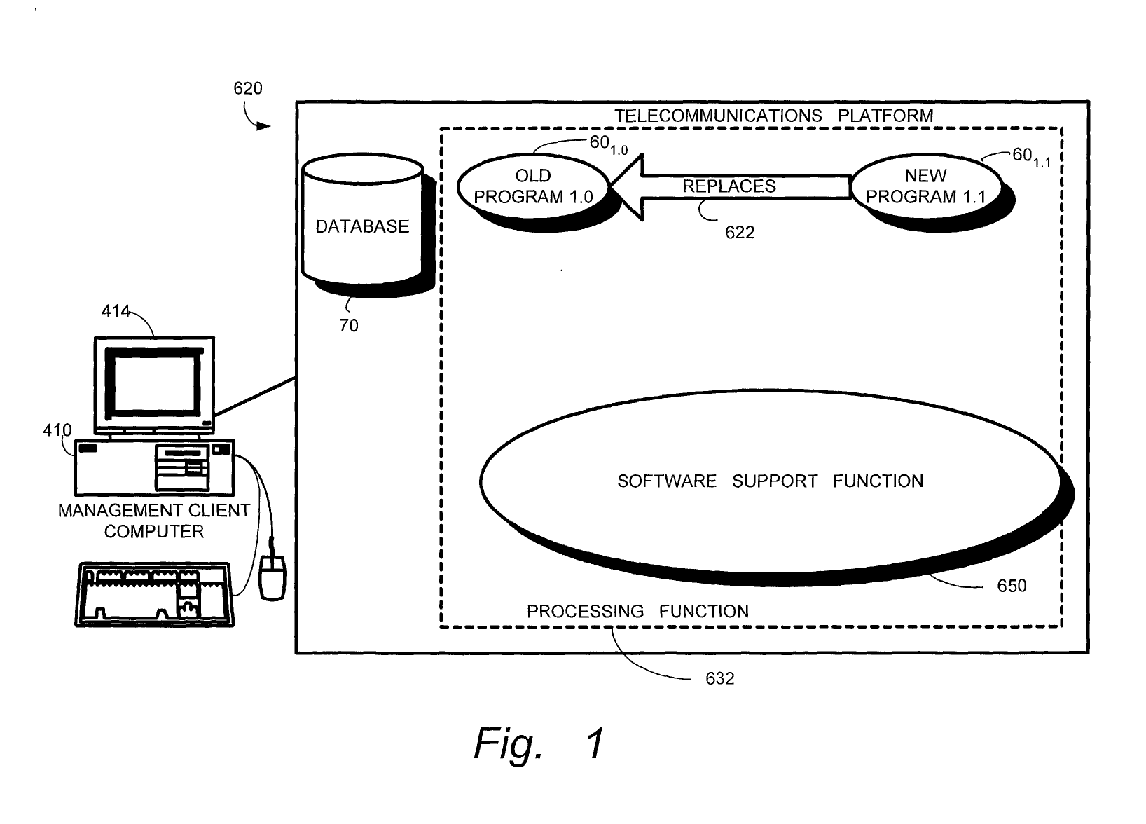

FIG. 1 shows a generic platform or node 620 of a telecommunications network, such as a cellular telecommunications network, for example. Various telecommunications components typically comprise telecommunications platform/node 620, such as those subsequently described. However, for sake of simplicity FIG. 1 primarily shows the platform/node 620 as having a processing function 632 for the telecommunications platform 620 and a data base memory 70. The processing function 632 may reside in a single processor of telecommunications platform 620, or (as described in more detail hereinafter) may be distributed to plural processors comprising telecommunications platform 620. The database memory 70, although illustrated as a peripheral memory in FIG. 1, can take various forms, such as (for example) a hard disk or semiconductor chip (e.g., RAM) memory.

An objective of the present invention is the replacement (e.g., upgrading) of software executed by processing function 632. For example, FIG. 1 shows a program (PGM) 60_{1.0} which has been executing on processing function 632, but for which a replacement is desired (e.g., an upgrade) resulting in program (PGM) 60_{1.1}. The software replacement operation performed by the present invention is generally depicted by arrow 622 in FIG. 1.

The software (program) replacement operation of the present invention involves usage of a management client computer 410 which is connected to telecommunications platform or node 620. The management client computer 410 executes management application software, and has a display device 414.

The processing function 632 of telecommunications platform 620 executes various programs that result from the loading of respective load modules. A load module is generated by a compiler or similar tool, and contains binary code generated from one or more source code files. Those source code file(s) contain one or more process definitions. The process definitions contain the sequence of source code instructions that are executed in one context as one process thread. The load module is output from the load module generating tool (e.g., compiler) as a file, and the software of the load module is presented to the system as a file. A load module includes certain “meta-data” which is used, e.g., to facilitate downloading of the load module. Examples of such meta-data include the following: target processor type; start phase; whether the load module is involved in redundancy or not. The meta-data is set at load module creation time and is stored at the node in a way so it will be connected to the load module to which it belongs. Preferably the meta-data is stored as a header in the beginning of a file with the load module itself.

FIG. 3 shows a load module as a software object which wraps together a group of related potentially executable processes. In particular, FIG. 3 shows an example load module (LM) 60 comprising process definitions 62₁- 62_{w}, with process definition 62₁ being the root process definition of the load module (LM) 60. The load module is created when the related process definitions are compiled and linked together.

A program, such as program 60_{1.1} of FIG. 1, is a running instance of a load module. That is, when a program is created when a load module is loaded into a processor. Thus, a program exists only in run time memory (RAM) of a processor and is created as a consequence of the loading of the corresponding load module. A program can be considered to contain one or more processes (corresponding to the processes of the load module whose loading created the program), and is represented in the operating system as a group of process blocks that contain, among other things, a program counter, a stack area, and information regarding running, suspension, and waiting states. The execution of a program can be aborted or suspended by the operating system, and then execution resumed subsequently.

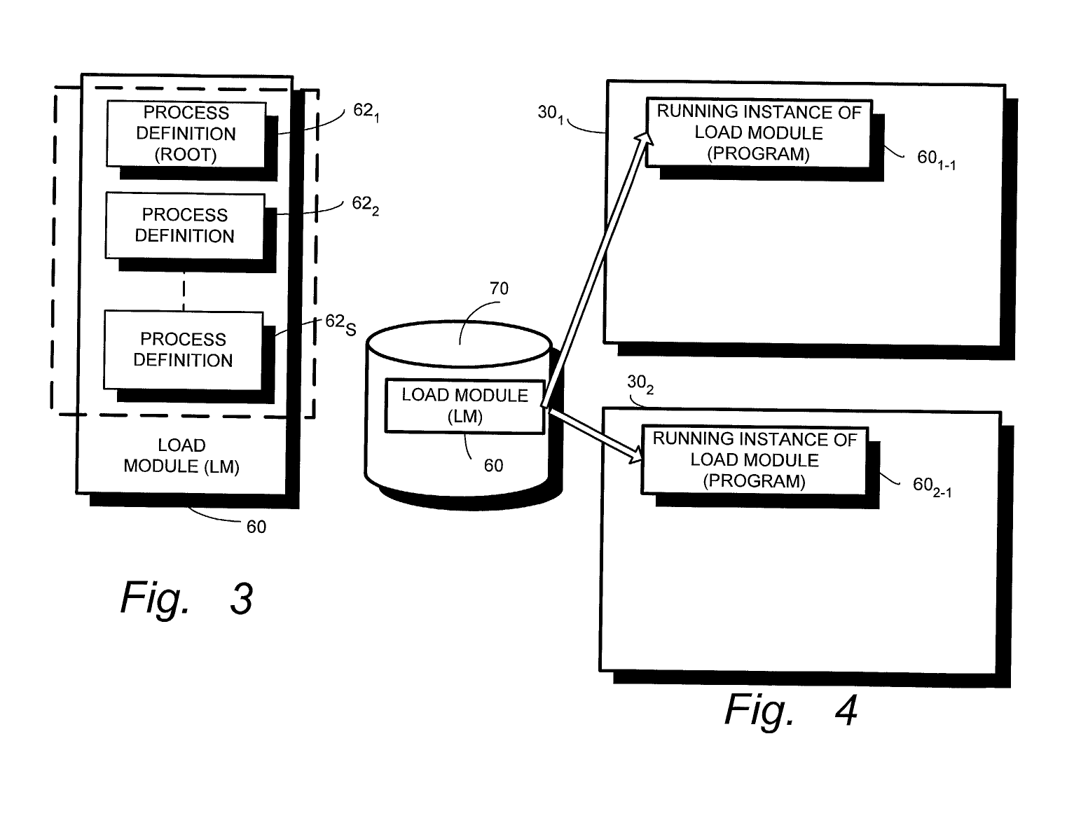

FIG. 4 shows load module 60 as stored in a persistent memory such as a data base 70. In addition, FIG. 4 shows that that load module 60 has been loaded onto processor 30₁, resulting in creation of a running instance of load module 60, i.e., program 60₁₋₁.

Similarly, load module 60 has been loaded onto processor 302, resulting in creation of a running instance of load module 60, i.e., program 60₂₋₁. In this embodiment, each load module is loaded once to a processor, and each processor is typically loaded with several different load modules.

Of particular interest to the present invention is that, in one embodiment, the load modules that are loaded to become the replaceable programs used with the present invention are designed to include a special shutdown function or process. For example, the example load module (LM) 60 of FIG. 3 includes shutdown process 62_{S} as one of its processes. Example actions performed by a program whose corresponding load module includes a shutdown process such as shutdown process 62_{S} are discussed subsequently.

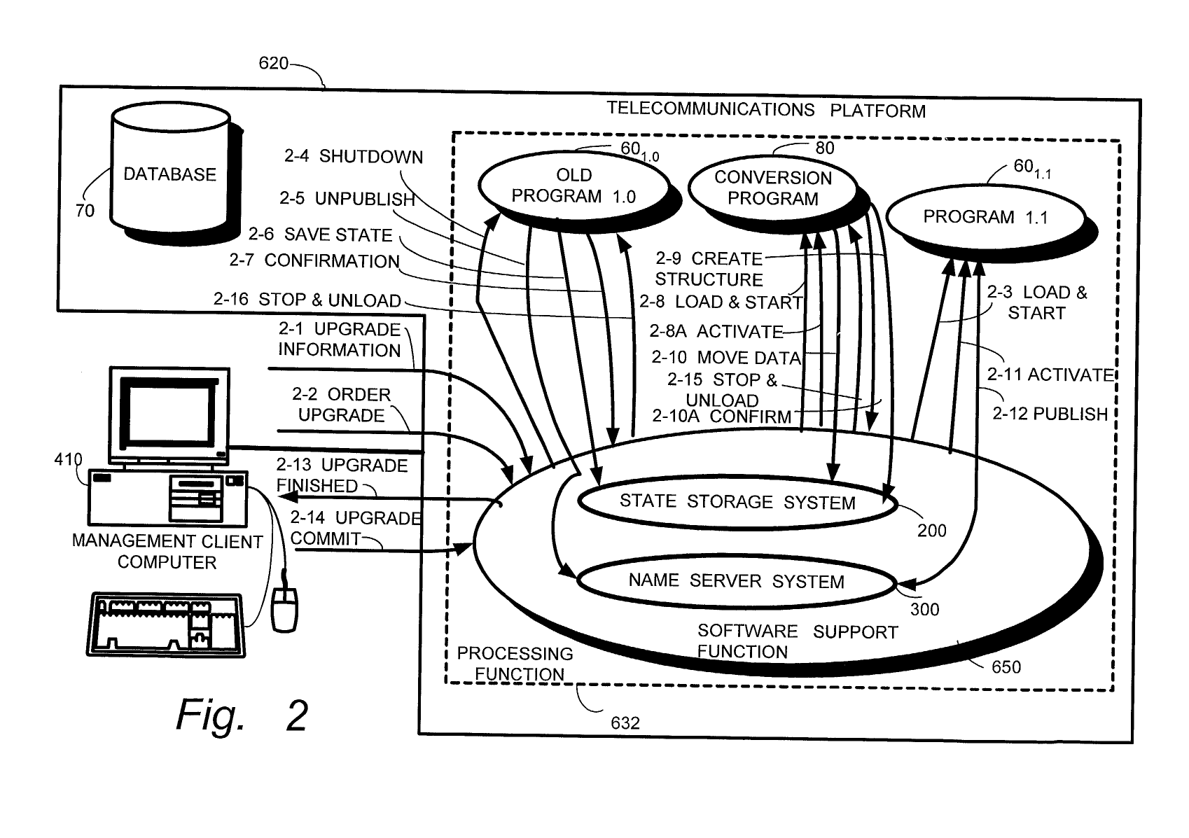

In accordance with the present invention, the programs which are to be upgraded are designed, via the definitional processes of their corresponding load module, to store certain state information. While the programs can store their state information at various times for diverse purposes (e.g., redundancy), in connection with the present invention the programs particularly store their state information when provided with a shutdown command as part of a software replacement (e.g., upgrade) scenario. What information is stored by an upgrading program depends on the particular program. The load module upon which the corresponding program is based is designed (coded) to know what data and process status information to store as state information. In other words, the application software is designed so that the application software itself knows what types of data needs to be stored in state storage system 200, and which of several save modes is to be implemented for that particular program. In this regard, the message of the store operation itself includes an identification of the program making the store; the data values to be stored; and a storage mode indicator. The state information is stored in a state storage system 200, illustrated in FIG. 2. The state storage system 200 can comprise any suitable fast access type of memory, such as RAM. The storage of state information including state data storage modes is described in U.S. patent application Ser. No. 09/_______, (attorney docket: 2380-182), entitled “Telecommunications Platform With Processor Cluster and Method of Operation Thereof”, which is incorporated herein by reference.

Each load module has a certain design name. However, when a load module is copied to and loaded on a processor, the running instance of the load module, i.e., the Auto program so loaded, is assigned a run-time name or run-time reference. Knowledge of the run-time name or run-time reference is necessary for one program to contact another program. But it is impossible for a client program, for example, to know in advance what is the run-time name for a certain server program which the client wishes to utilize. The difficulty is even more complex in a multi-processing environment in which it is not known in advance upon which processor a program may execute, or in which programs may move around from one processor to another (e.g., in the case of a take over of the program by another processor, which can occur upon fault of a first processor, etc.).

In view of the foregoing, and in accordance with the example embodiment of FIG. 2, software processing function 650 includes a name server system 300 which associates the run time reference (e.g., run time name) of a program with the published design name. Upon publication of a design name of a program, the name server system 300 associates the run time reference with the design name of the program and supervises execution of the program. Upon assigning the run time reference to a design name, name server system 300 creates an entry (record) in a name table maintained by name server system 300. An example name table 304 is shown in FIG. 11, showing records which correlate the published design name and the run time reference.

FIG. 2 illustrates various example actions that are involved in a software (program) replacement operation in accordance with one mode of the invention. In the particular situation depicted in FIG. 2, the replacement happens to be a software upgrade. The example of FIG. 2 is just one possible scenario. For example, it should be understood that the events/actions of FIG. 2 can be differently ordered (e.g., different permutations of messages) and still bring the overall system to the same state as the sequence described in FIG. 2.

As a first such action 2-1, the operator/user employs management client computer 410 to provide certain upgrade information to software processing function 650. The upgrade information of action 2-1 can include, for example, (1) an identification of the program which is to be upgraded (e.g., program 60_{1.0} in the illustrated scenario); (2) an identification of a load module including a conversion program to be employed in the upgrade; and (3) an identification of the new version of the load module from which the replaced program originated (e.g., program 60_{1.1} in the illustrated scenario).

After the preparatory action of providing upgrade information (action 2-1), the operator/user via management client computer 410 issues an upgrade order or command as action 2-2 to software processing function 650. As a consequence, and depicted by action 2-3, the software processing function 650 loads the new version of the load module and starts the corresponding upgraded program 60_{1.1}.

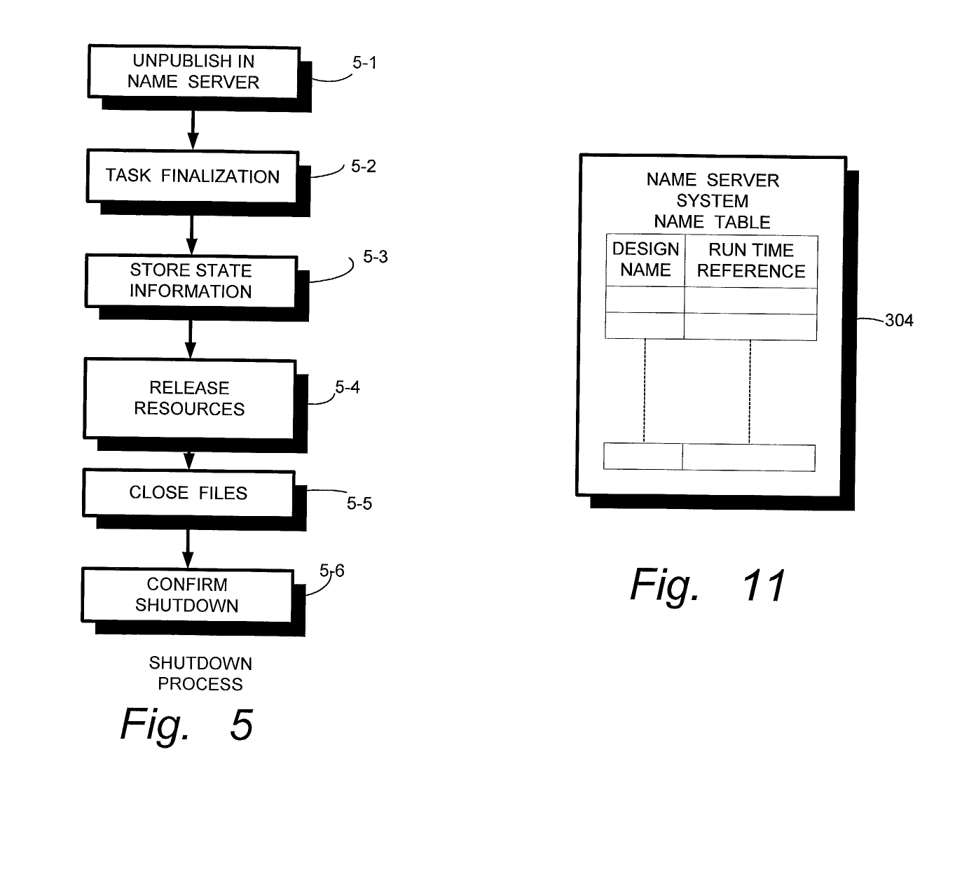

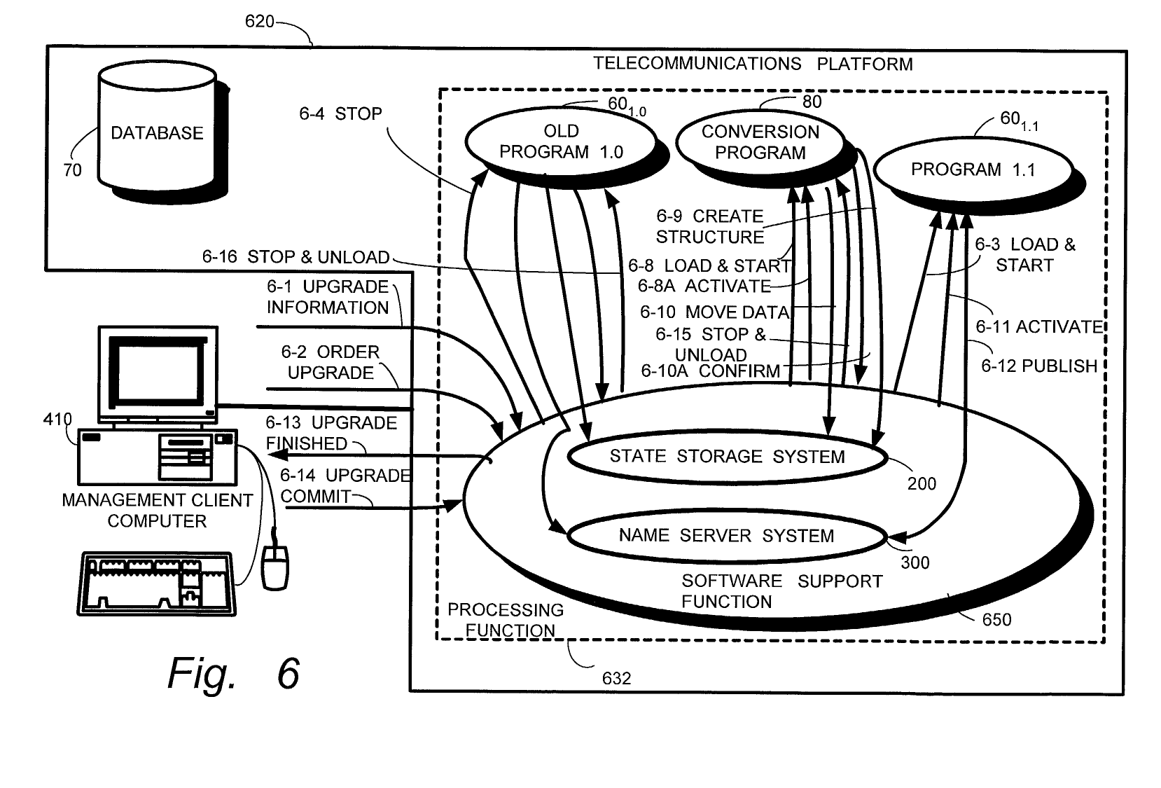

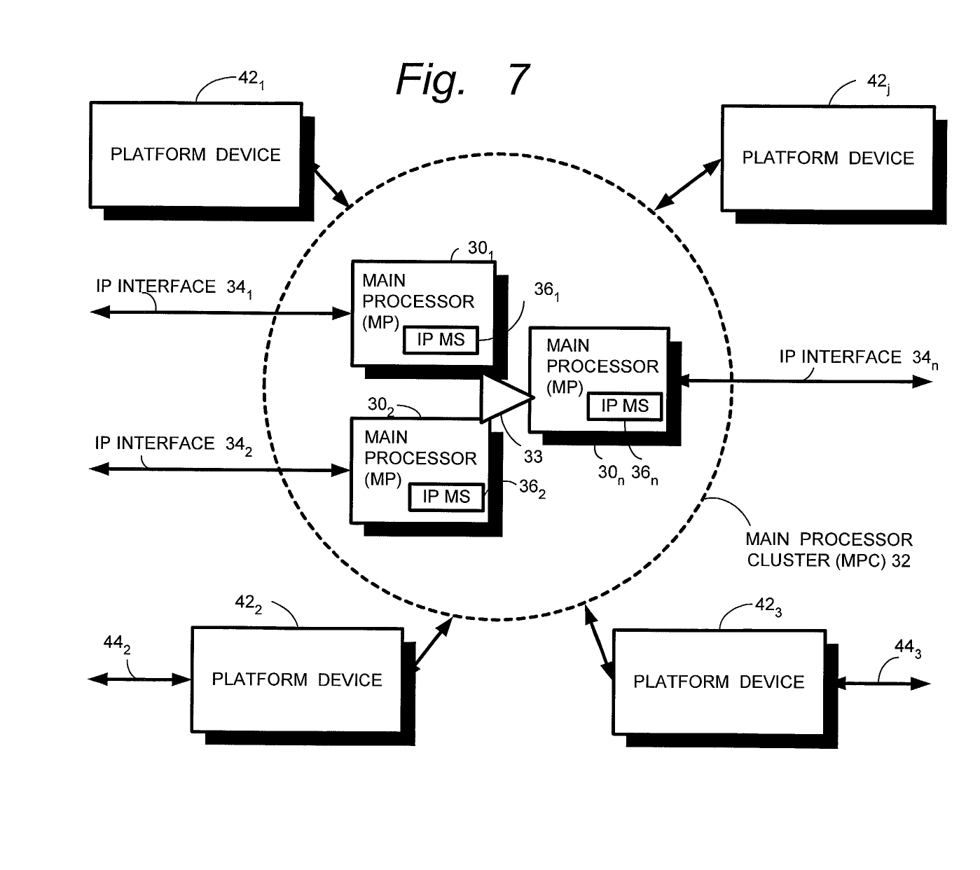

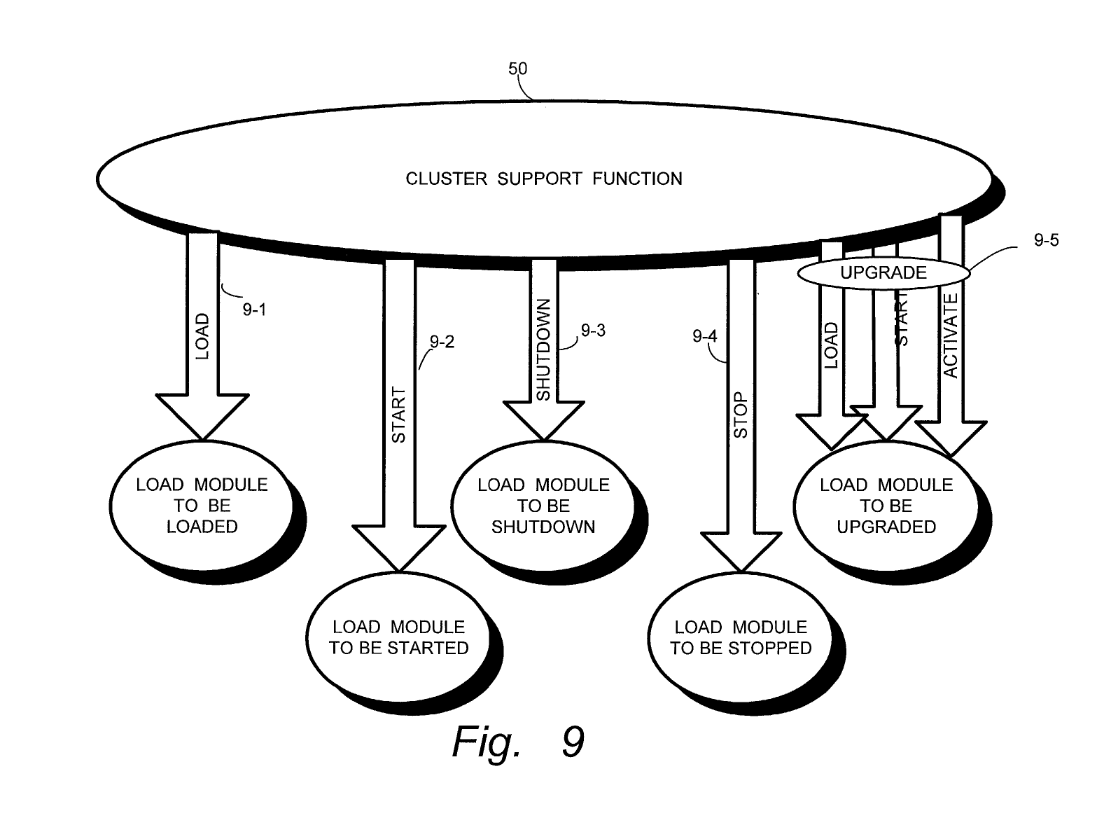

Having loaded and started program 60_{1.1}, as action 2-4 the software processing function 650 issues a shutdown command to program 60_{1.0}. When a program is to be shutdown (see shutdown message 9-3 in FIG. 9), cluster support function 50 uses a software hook to request the software application to prepare its termination. In response to the shutdown command of action 2-4, program 60_{1.0} performs the basic activities depicted in FIG. 5. The shutdown preparation activities for any particular program depend on nature of the application, but typically involve the basic activities as illustrated in FIG. 5.

As shutdown activity 5-1, program 60_{1.0} unpublishes itself in name server system 300. In this regard, FIG. 2 depicts program 60_{1.0} as sending an unpublish message as action 2-5 to name server system 300 of software processing function 650. Upon receipt of the unpublish message of action 2-5, name server system 300 removes from its name table 304 the record for program 60_{1.0}. Whereas, for the most part, the order of the shutdown preparation activities of FIG. 5 is not critical, the unpublish shutdown activity should occur early. After unpublishing, as shutdown activity 5-2 program 60_{1.0} performs task finalization so that the execution of program 60_{1.0} can be stopped without aborting any ongoing tasks.

As shutdown activity 5-3 of its shutdown process 62_{S}, program 60_{1.0} saves its state information. A save state message from program 60_{1.0} to state storage system 200 is shown as action 2-6 in FIG. 2. The state data is stored, e.g., in data structures in state storage system 200. Further, the stored state data is given an identifier which serves as a parameter, e.g., for locating the state information for operations from the program to state storage system 200, such as (for example) update, read, and move operations. As explained above, the state data stored by a program subject to upgrade is sufficient for the new version of the program to resume operation after the upgrade. Thus, the software processing function 650 with its state storage system 200 makes it possible for the new program (e.g., program 60_{1 1}) to fetch the state saved by the old program (e.g., program 60_{1.0}) at the time of the software (program) upgrade operation.

As shutdown activity 5-4, the program 60_{1.0} then releases any resources which it has utilized, and then closes files which it has utilized (shutdown activity 5-5). Lastly, as activity 5-6 of its shutdown process 62_{S}, the program 60_{1.0} confirms that it has completed its shutdown. FIG. 2 shows program 60_{1.0} as issuing a confirmation message as action 2-7.

With program 60_{1.0} having completed its shutdown process 62_{S}, conversion program 80 is loaded and started as action 2-8. When started, the conversion program 80 functions to convert data structures (e.g., in data base(s), state storage system, and file system(s), etc.) employed by program 60_{1.0}(e.g., the old version of the data) to a new version of data that will be usable by the upgraded program 60_{1.1}. Preferably, conversion program 80 is designed to support upgrading from one or several given versions of a program to one given new version of that program.

Conversion program 80 is wrapped within a corresponding load module. That load module which corresponds to conversion program 80 is specified at action 2-1 with, e.g., information sufficient for the software support function 650 to know which load module (stored in database 70) is to be loaded into random access memory in order to convert the data structures utilized by the old program that is the target of the upgrade operation. The load module containing conversion program 80 can be loaded either at action 2-1, action 2-2, or action 2-8. However, conversion program 80 is activated at action 2-8.

Following loading and activation of conversion program 80, an identifier of the state data stored by the old version of the program (e.g., program 60_{1.0}) is provided to conversion program 80. Then, as action 2-9, conversion program 80 creates data structures (e.g., in the file system, state storage system 200, and database 70) for the new version of the program (e.g., program 60_{1.1}). Action 2-10 moves data from the old data structures in state storage system 200 to the new data structures in state storage system 200 and in database 70. The move operation essentially instructs the state storage system to move applicable parts of state data associated a given identifier from one data structure to another. Typically there is a need to add new data, or to alter the value of the moved data by the conversion program 80. Then, as action 2-10A, conversion program 80 sends a message to software support function 650 confirming that conversion program 80 has completed its conversion.

As action 2-11, software processing function 650 activates the upgraded program (e.g., program 60_{1.1} in the illustrated example). Upon being activated, as action 2-12, the upgraded program publishes itself in name server system 300. In other words, the upgraded program advises name server system 300 of its design name, so that name server system 300 can create an entry for the upgraded program in name table 304 (see FIG. 11) and associate the upgraded program with the run time reference.

After the upgraded program has been activated, as action 2-13 the software processing function 650 provides a message to the operator/user via management client computer 410 that the software (program) upgrade operation has been completed. At this point, the new software of the upgraded program (e.g., program 60_{1.1}) is running. The operator may evaluate whether the upgraded program is working properly and if the software (program) upgrade operation was successful. If the operator/user approves of the software (program) upgrade operation, as action 2-14 the operator/user can issue an upgrade commit command via management client computer 410 to software processing function 650, which allows continuation of execution of the new version of the program and also prohibits execution of the old version of the program.

Upon receipt of the commit command (action 2-14), the software processing function 650 stops conversion program 80 as indicated by action 2-15. The conversion program 80 will also be unloaded as part of action 2-15. Alternatively, for reasons not applicable to the scenario of FIG. 2, the conversion program 80 can be left in random access memory. Further, as action 2-16, software processing function 650 unloads the old program (e.g., program 60_{1.0} in the example scenario of FIG. 2).

Upon being provided with the upgrade completion message of action 2-13, the operator/user may determine that the software (program) upgrade operation was not successful, or for some other reason the upgraded should be reversed. If such is the case, in lieu of the upgrade commit command of action 2-14, the operator/user may issue a rollback command. If a rollback command is issued, conversion program 80 will re-convert all data structures, etc., to the previous version usable by the old program (e.g., program 60_{1.0}). Further, the new version of the program (e.g., program 60_{1.1}) will be deactivated and unloaded, and the old program will continue the task of the program.

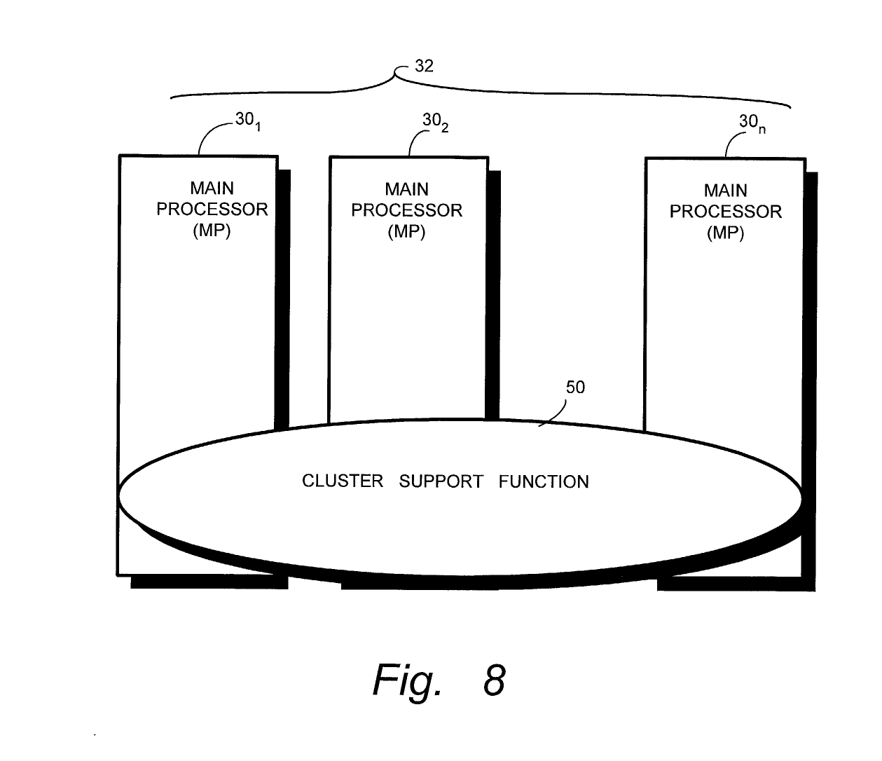

FIG. 6 illustrates various actions that are involved in a software (program) upgrade operation in accordance with another mode of the invention. The example of FIG. 6 basically differs from that of FIG. 2 in not having a shutdown function for the old program. Rather, the reboot upgrade of the mode of FIG. 6 essentially stops the old program. As explained below, conversion program 80 is still required for the mode of FIG. 6.

Actions 6-1 through 6-3 of the mode of FIG. 6 resemble actions 2-1 through 2-3 of FIG. 2, respectively, and therefore are discussed only briefly. As action 6-1 certain upgrade information is provided to software processing function 650. An upgrade order or command is issued as action 6-2 to software processing function 650. In response to the upgrade order, as action 6-3 the software processing function 650 loads and starts the upgraded program 60_{1.1}.

Having loaded and started program 60_{1.1}, as action 6-4 the software processing function 650 issues a stop command (rather than a shutdown command) to program 60_{1.0}. Since the program 60_{1.0} is stopped, program 60_{1.0} cannot perform any of the tasks indicated by actions 6-5 through 6-7. In other words, program 60_{1.0} does not engage in the shutdown activities previously described with respect to shutdown process 62_{S} and FIG. 5. In the above regard, the name server system 300 has a mechanism that supervises all published programs. When that supervisory mechanism detects that program 60_{1.0} has stopped, name server system 300 removes the corresponding entry for program 60_{1.0} from its name table (see, e.g., FIG. 11), thereby effectively unpublishing the name for program 60_{1.0}.

With program 60_{1.0} having been stopped as action 6-4, the software processing function 650 loads and starts conversion program 80.

Activate action 6-8A is then performed to bring the identifier of the state data stored by the old version of the program (e.g., program 60_{1.1}) to conversion program 80. Then, as action 6-9, conversion program 80 creates data structures (e.g., in the file system, state storage system 200, and database 70) for the new version of the program (e.g., program 60_{1.1}). Action 6-10 moves data from the old data structures in state storage system 200 to the new data structures in state storage system 200 and in database 70. Then, as action 6-10A, conversion program 80 sends a message to software support function 650 confirming that conversion program 80 has completed its conversion.

It will thus be appreciated that, in contrasting the FIG. 6 mode with the FIG. 2 mode, that the advantage of the shutdown action 2-4 of the FIG. 2 mode is that the data at the time of shutdown will be securely saved as state data. The old program 60_{1.0} may frequently, e.g., continuously, be storing state data during its execution. But with no shutdown as occurs in the FIG. 2 mode, there is a chance (e.g., in the FIG. 6 mode) that the stop of program 60_{1.0}(caused by action 6-4) can potentially interrupt the program as it is changing state data but before it has an opportunity to store the changed state data.

As action 6-11, software processing function 650 activates the upgraded program (e.g., program 60_{1.1} in the illustrated example). Upon being activated, as action 6-12, the upgraded program publishes itself in name server system 300, in like manner as above-described relative, e.g., to action 2-12. Then, after the upgraded program has been provided with its run time reference, as action 6-13 the software processing function 650 provides a message to the operator/user via management client computer 410 that the software (program) upgrade operation has been completed.

At this point, the new software of the upgraded program (e.g., program 60_{1.1}) is running. In similar manner as previously described with reference to FIG. 2, the operator may evaluate whether the upgraded program is working properly and if the software program) upgrade operation was successful. If the operator/user approves of the software (program) upgrade operation, as action 6-11 the operator/user can issue an is upgrade commit command via management client computer 410 to software processing function 650, which allows continuation of execution of the upgraded program. Alternatively, as previously discussed, the operator/user can issue a rollback command.

Upon receipt of the commit command (action 6-14), the software processing function 650 stops conversion program 80 as indicated by action 6-15. The conversion program 80 will also be unloaded as part of action 6-15. Further, as action 6-16, software processing function 650 unloads the old program (e.g., program 60_{1.0} in the example scenario of FIG. 6).

Thus, when a program is merely to be stopped in an software (program) upgrade operation such as the mode of FIG. 6, the program is stopped without the benefit of any preparations such as those performed in the mode of FIG. 2 involving shutdown process 62_{S}.

As mentioned above, processing function 632 can be comprised of one or plural processors. In this regard, FIG. 7 shows an example generic multi-processor platform 20 of a telecommunications network, such as a cellular telecommunications network, for example, according to the present invention. The telecommunications platform 20 of the present invention has a central processing resource of the platform distributed to plural processors 30, each of which is referenced herein as a main processor or MP. Collectively the plural main processors 30 comprise a main processor cluster (MPC) 32. FIG. 7 shows the main processor cluster (MPC) 32 as comprising n number of main processors 30, e.g., main processors 30ₗ through 30ₙ.

The main processors 30 comprising main processor cluster (MPC) 32 are connected by inter-processor communication links 33. The transport layer for communication between the main processors 30 is not critical to the invention. Furthermore, one or more of the main processors 30 can have an internet protocol (IP) interface 34 for connecting to data packet networks.

FIG. 7 shows j number of platform devices 42 included in telecommunications platform 20. The platform devices 42ₗ-42ⱼ can, and typically do, have other processors mounted thereon. In some embodiments, the platform devices 42ₗ-42ⱼ, are device boards. Although not shown as such in FIG. 7, some of these device boards have a board processor (BP) mounted thereon for controlling the functions of the device board, as well as special processors (SPs) which perform dedicated tasks germane to the telecommunications functions of the platform.

Although not specifically illustrated as such, there are communication channels from all platform devices 42 to all main processors 30 over an intra-platform communications system. Examples of intra-platform communications system include a switch, a common bus, and can be packet oriented or circuit switched. In addition, there are communication channels (over inter-processor communication links 33) between all main processors 30 in the main processor cluster (MPC) 32.

Some of the platform devices 42 connect externally to telecommunications platform 20, e.g., connect to other platforms or other network elements of the telecommunications system. For example, platform device 422 and platform device 423 are shown as being connected to inter-platform links 442 and 443, respectively. The inter-platform links 442 and 443 can be bidirectional links carrying telecommunications traffic into and away from telecommunications platform 20. The traffic carried on inter-platform links 442 and 443 can also be internet protocol (IP) traffic which is involved in or utilized by an IP software application(s) executing in management service (IP MS) section 36 of one or more main processors 30.

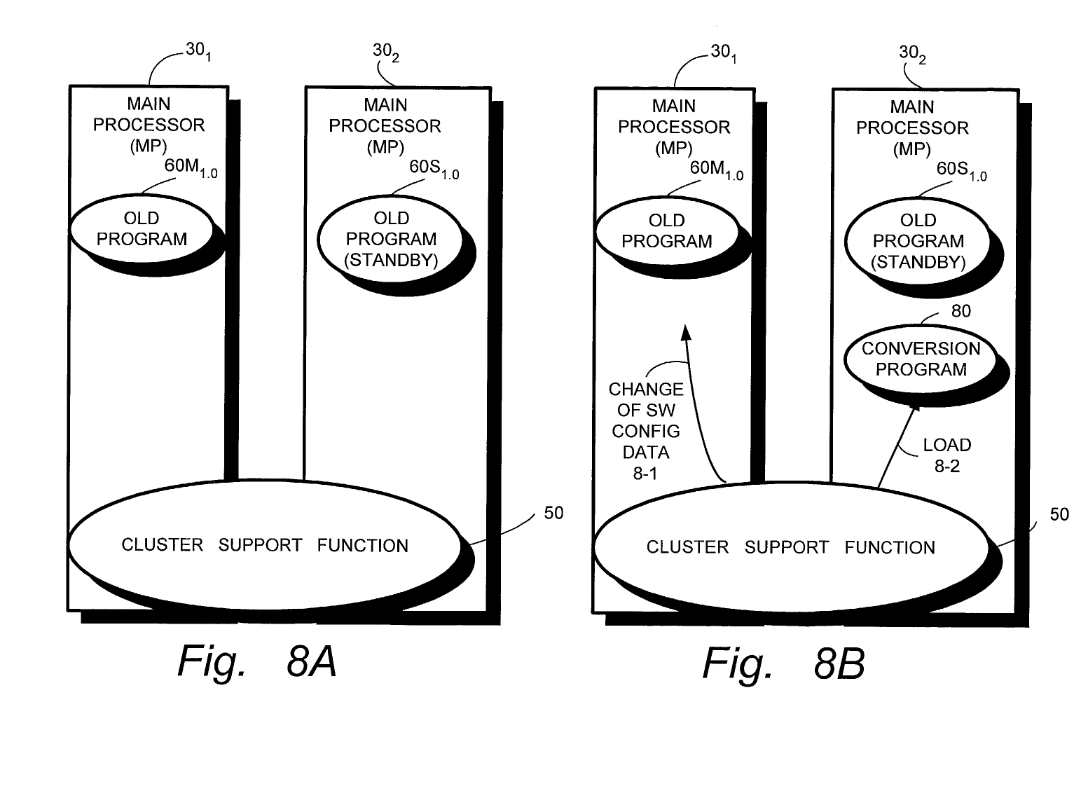

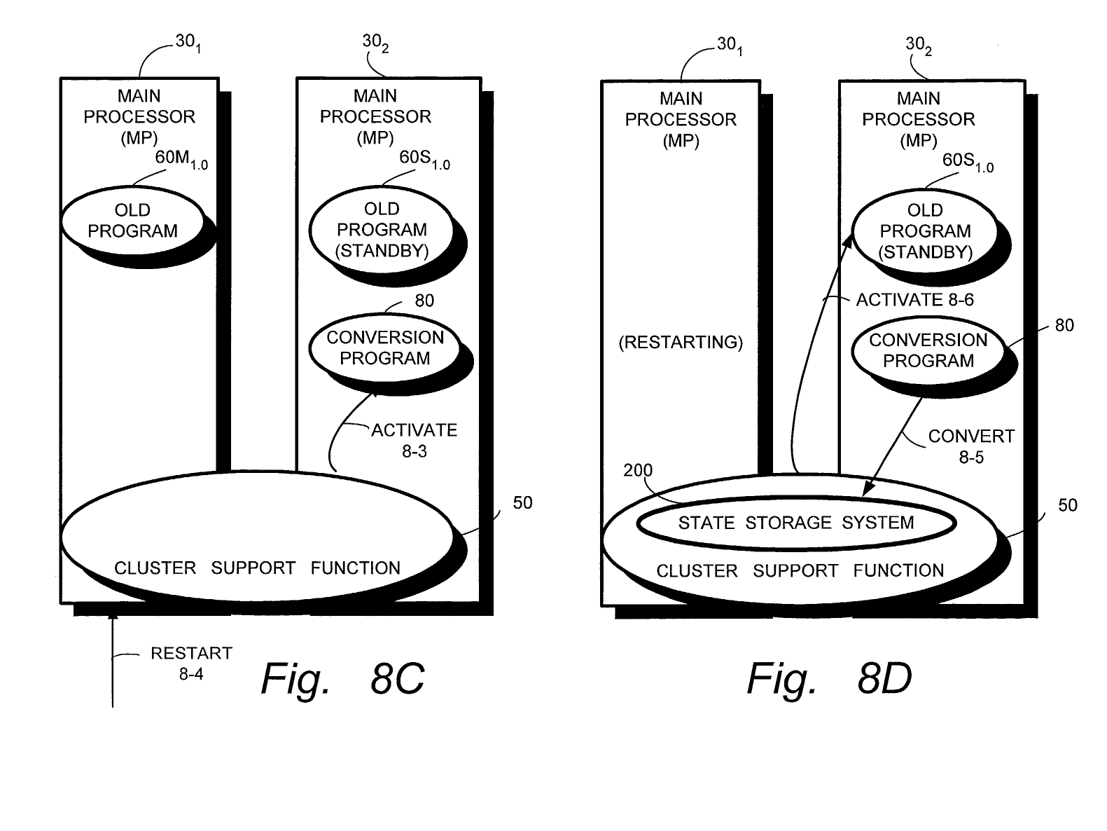

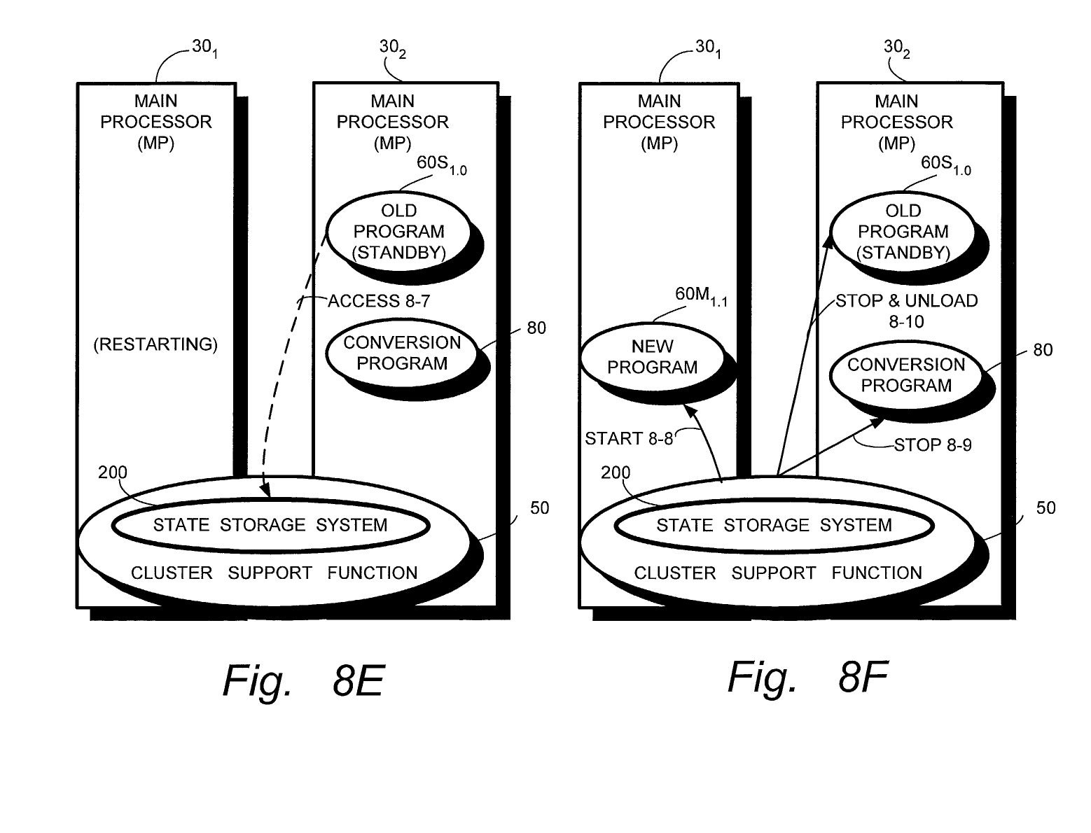

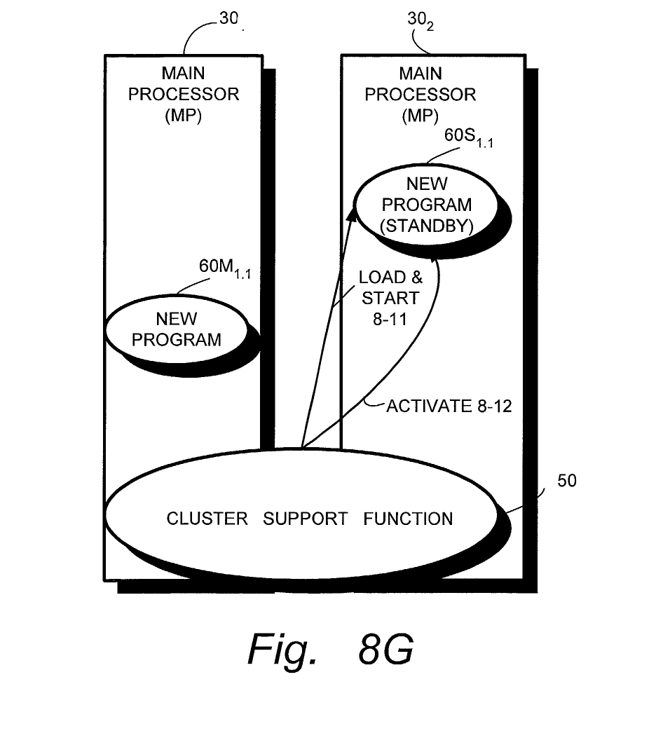

As shown in example fashion in FIG. 8 and hereinafter described, main processor cluster (MPC) 32 has cluster support function 50 which is distributed over the main processors 30 belonging to main processor cluster (MPC) 32. The cluster support function 50 enables a software designer to implement application software that is robust against hardware faults in the main processors 30 and against faults attributable to software executing on main processors 30. Moreover, cluster support function 50 facilitates upgrading of application software during run time with little disturbance, as well as changing processing capacity during run time by adding or removing main processors 30 in main processor cluster (MPC) 32. The main processor cluster (MPC) 32 of FIG. 8 is analogous to the processing function 632 of FIG. 2. In the multi-processor embodiments, the cluster support function 50 performs the functions of the software support function 650 mentioned in the earlier-described embodiments.

The cluster support function 50 implements redundancy mechanisms of the main processor cluster (MPC) 32, e.g., using both active and standby programs. In other words, for certain programs there is, in reality, a program pair. A first member of the pair is an active program; a second member of the pair is a standby program. Certain redundancy aspects of cluster support function 50 are described in U.S. patent application Ser. No. 09______/______ , (attorney docket: 2380-182), entitled “Telecommunications Platform With Processor Cluster and Method of Operation Thereof”, which is incorporated herein by reference.

FIG. 8A-FIG. 8G illustrate certain events involved with an example replacement procedure for replacement of an old master program 60M_{1.0} with a replacement or new program 60M_{1.1}. It should be understood that, unless clear from the context, the order of some of the steps in FIG. 8A-FIG. 8G is not necessarily in accordance with the step numbering.

FIG. 8A shows the pre-existing situation in which old master program 60M_{1.0} is running on processor 30₁ of main processor cluster (MPC) 32, while its counterpart old standby program 60S_{1.0} is running on processor 30₂ of main processor cluster (MPC) 32.

As a first step in the replacement procedure, step 8-1 shown in FIG. 8B involves altering of the software (SW) configuration data describing what to load on processor 30₁, so that program 60_{M}_{1.1} will be loaded and started at next restart of processor 30₁. Simultaneously or subsequently, a conversion program 80 is loaded on processor 30₂, as indicated by step 8-2 of FIG. 8B.

FIG. 8C depicts activation of conversion program 80 as step 8-3, and restarting of processor 30₁ as step 8-4. In accordance with the example scenario herein described, program substitution or replacement occurs by restarting the processor (e.g., processor 30₁) with reload. The software to reload is determined by the software configuration of that processor. Thus, an upgrade or replacement procedure can be achieved by restarting and reloading the processor according to the new software configuration.

FIG. 8D illustrates, as step 8-5, the conversion program 80 beginning to convert state data structures stored by old master program 60M_{1.0}. In addition, as shown by step 8-6, the standby copy 60_{1.0} of the old master program becomes activated (as a consequence of step 8-4). Further, as represented by step 8-7 in FIG. 8E, the standby copy 60S_{1.0} may start accessing/altering the old version of the state data which is being converted by conversion program 80 in state storage system 200. If such access occurs, conversion program 80 has to consider the updated item in its conversion process. An “updated item” is an item or recorded which is part of the state data, but which has been altered by the standby program. In this regard, the conversion program 80 must be able to convert structures while they are in use, e.g., when a program is storing data in the old structure the conversion program 80 must be notified and be able consequentially to move data from the old to the new data structures whenever an item is written. This requires subscription mechanisms where a conversion program can request indications when a program updates its given structures.

During restart of processor 30, and before start of the new program, the functionality formerly provided by old master program 60M_{1.0} is performed by the standby copy 60S_{1.0} of the old master program. FIG. 8F depicts (as step 8-8) the start of the master copy of the new program 60M_{1.1} on the restarted processor 30₁. In addition, FIG. 8F shows (by respective steps 8-9 and 8-10) the stopping and loading of both conversion program 80 and the standby copy 60S_{1.0} of the old master program. FIG. 8G illustrates the subsequent loading and activating of the standby copy 60S_{1.1} of the new master program (steps 8-11 and 8-12, respectively). Thus, programs running on processor 30₁ that are designed to be fault tolerant by having a standby copy present on another processor have their standby copies activated as a consequence of the restart, as illustrated by step 8-12.

The foregoing description of FIG. 8A-FIG. 8G thus describes the use of main processor cluster (MPC) 32 in conjunction with software replacement (e.g., upgrade) mechanisms. The software (program) upgrade operation of the FIG. 8 mode of the invention is thus a restart method that upgrades all programs on one processor at the same time. This restart mode saves time, but does cause some disturbance of the system. The FIG. 2 and FIG. 6 embodiments, on the other hand, are not restart methods.

In some utilizations, combinations of the restart method and the non-restart method may be employed, perhaps in a complex manner. Yet the pure restart mode of FIG. 8 shows how the standby programs (even in such hybrid modes) can influence the upgrade mechanisms, such influence being germane both to the restart and non-restart modes.

The ability of the conversion program 80 to convert data structures while the data structures are in use is beneficial not only in the scenario described above, but also in other upgrade/replacement cases in order to decrease the time period during which the service subject for upgrade is inaccessible. If this on going convert capability is employed it can change the sequence of steps described in FIG. 2 and FIG. 6, in that it would not be necessary to wait for conversion program 80 to finish its task before the new version of the program is activated.

As illustrated in FIG. 9, the stop, load, and start action shown as actions 6-4 in FIG. 6 and 2-4 in FIG. 2, respectively, symbolize different actions initiated by cluster support function 50 to a program. In fact, in one embodiment of the invention, these actions are more like a method which act on the load module entity, and are fully supported by operating system mechanisms (e.g., OSE-Delta mechanisms) so that the load module involved does not have to take them into consideration. The activate and shutdown messages are signals sent from the cluster support function 50 to the program. The program, therefore, must contain receive statements for these signals. The upgrade message is not a discrete message, but several messages involving loading, starting, and activating towards the conversion load module/program as previously described. The cluster support function 50 itself does, however, receive an upgrade message from the operator (see, e.g., action 2-2, which is not to be confused with action 9-5).

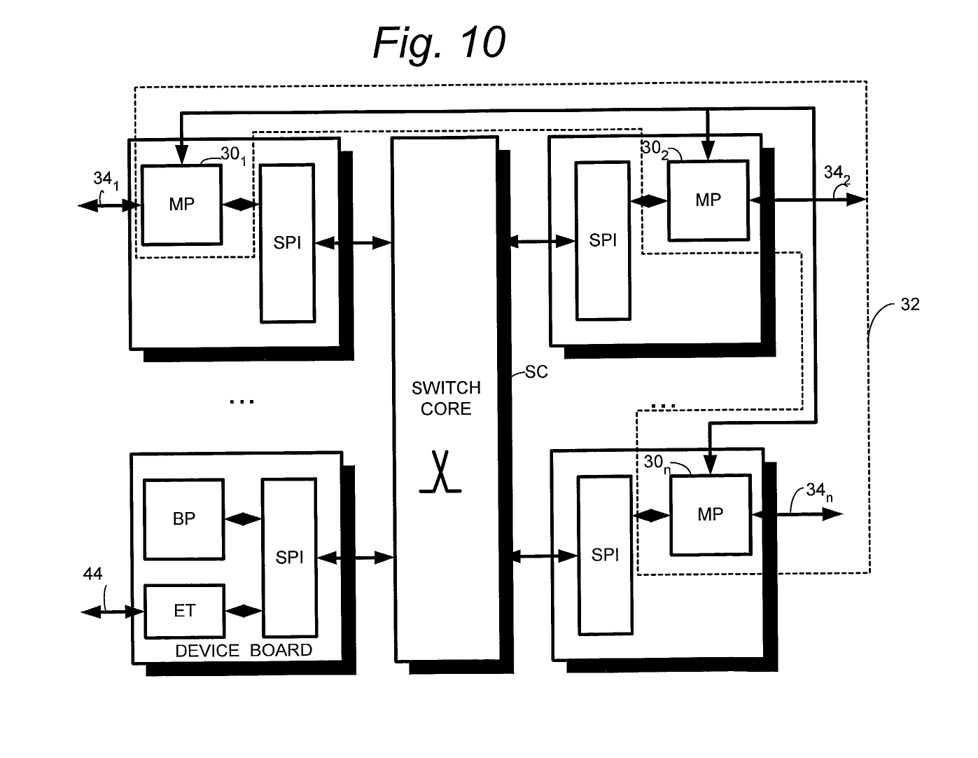

FIG. 10 shows one example embodiment of a ATM switch-based telecommunications platform having the cluster support function 50, including state storage system 200 and name server system 300. In the embodiment of FIG. 10, each of the main processors 30 comprising main processor cluster (MPC) 32 are situated on a board known as a main processor (MP) board. The main processor cluster (MPC) 32 is shown framed by a broken line in FIG. 10. The main processors 30 of main processor cluster (MPC) 32 are connected through a switch port interface (SPI) to a switch fabric or switch core SC of the platform. All boards of the platform communicate via the switch core SC. All boards are equipped with a switch port interface (SPI). The main processor boards further have a main processor module. Other boards, known as device boards, have different devices, such as extension terminal (ET) hardware or the like. All boards are connected by their switch port interface (SPI) to the switch core SC.

Whereas the platform of FIG. 10 is a single stage platform, it will be appreciated by those skilled in the art that the software replacement function of the present invention can be implemented in a main processor cluster (MPC) realized in multi-staged platforms. Such multi-stage platforms can have, for example, plural switch cores (one for each stage) appropriately connected via suitable devices. The main processors 30 of the main processor cluster (MPC) 32 can be distributed throughout the various stages of the platform, with the same or differing amount of processors (or none) at the various stages.

Various aspects of ATM-based telecommunications are explained in the following: U.S. patent applications Ser. No. 09/188,101 [PCT/SE98/02325] and Ser. No. 09/188,265 [PCT/SE98/02326] entitled “Asynchronous Transfer Mode Switch”; U.S. patent application Ser. No. 09/188,102 [PCT/SE98/02249] entitled “Asynchronous Transfer Mode System”, all of which are incorporated herein by reference.

As understood from the foregoing, the present invention is not limited to an ATM switch-based telecommunications platform, but can be implemented with other types of platforms. Moreover, the invention can be utilized with single or multiple stage platforms. Aspects of multi-staged platforms are described in U.S. patent application Ser. No. 09/249,785 entitled “Establishing Internal Control Paths in ATM Node” and U.S. patent application Ser. No. 09/213,897 for “Internal Routing Through Multi-Staged ATM Node,” both of which are incorporated herein by reference.

The present invention applies to many types of apparatus, such as but not limited to) telecommunications platforms of diverse types, including (for example) base station nodes and base station controller nodes (radio network controller [RNC] nodes) of a cellular telecommunications system. Example structures showing telecommunication-related elements of such nodes are provided, e.g., in U.S. patent application Ser. No. 09/035,821 [PCT/SE99/00304] for “Telecommunications Inter-Exchange Measurement Transfer,” which is incorporated herein by reference.

Various other aspects of cluster support function 50 are described in the following, all of which are incorporated herein by reference: (1) U.S. patent application Ser. No. 09/______,______ (attorney docket: 2380-182), entitled “Telecommunications Platform With Processor Cluster and Method of Operation Thereof”; (2) U.S. patent application Ser. No. 09/467,018 filed Dec. 20, 1999, entitled “Internet Protocol Handler for Telecommunications Platform With Processor Cluster”; (3) U.S. patent application Ser. No. 09/______,______ (attorney docket: 2380-180), entitled “Software Distribution At A Multi-Processor Telecommunications Platform”.

Advantageously, the present invention does not require extra processors to handle software replacements, but can use existing processors, particularly processors of main processor cluster (MPC) 32. Further, the invention allows upgrade of software (e.g., programs) during run time with little disruption or disturbance, and without shutting down the processing function 632 (e.g., main processor cluster (MPC) 32) and without shutting down the telecommunications platform or node.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A telecommunications platform comprising a processor function, the processor function including a software support function which implements a software (program) replacement operation to replace an old program with an new program, the software support function performing the following steps without stopping the processor function:
starting the new program;
shutting down or stopping the old program; and
activating a conversion program to render state information of the old program as converted state information usable by the new program.

2. The apparatus of claim 1, wherein the software support function further performs the step of saving state information of the old program before the old program is stopped or shut down.

3. The apparatus of claim 1, wherein the software support function further performs the steps of:
unpublishing the old program in a name server system upon receipt of an unpublish message from the old program;
publishing the new program in the name server system upon receipt of a publish message from the new program.

4. The apparatus of claim 1, wherein the platform is one of a base station node and a radio network controller node of a cellular telecommunications system.

5. A telecommunications platform comprising a cluster of processors which perform a platform main processing function, wherein a software cluster support function distributed to the cluster of processors implements a software (program) replacement operation to replace an old program executing on a first processor of the cluster with an new program, the software support function performing the following steps:
activating a standby copy of the old program on a second processor of the cluster;
executing the standby copy of the old program until a master copy of the new program is started by restart of the first processor;
staring the master copy of the new program by restarting the first processor;
loading a standby copy of the new program upon restart of the first processor.

6. The apparatus of claim 1, wherein the software support function performs the step of activating a conversion program on the second processor of the cluster.

7. The apparatus of claim 6, wherein the conversion program renders state information of the old program as converted state information usable by the new program.

8. In a telecommunications platform comprising a processor function, a program replacement method comprising:
(1) starting execution of a new program to replace an old program, the old program having stored state information prior to the starting of execution of the new program;
(2) executing a conversion program which renders the state information of the old program as converted state information usable by the new program executed by the processor function;
(3) providing the converted state information to the new program for use of the converted state information by the new program;
wherein steps (1)-(3) are performed without stopping shutting down the telecommunications platform.

9. The method of claim 8, further comprising saving state information of the old program during the program replacement method before the old program is stopped or shut down.

10. The method of claim 8, further comprising:
unpublishing the old program in a name server system;
publishing the new program in the name server system.

11. A method of operating a telecommunications platform comprising a cluster of processors which perform a platform main processing function, wherein a software cluster support function distributed to the cluster of processors implements a software (program) replacement operation to replace an old program executing on a first processor of the cluster with an new program, the method comprising:
activating a standby copy of the old program on a second processor of the cluster;
executing the standby copy of the old program until a master copy of the new program is started by restart of the first processor;
restarting the first processor to start the master copy of the new program; and
loading a standby copy of the new program upon restart of the first processor.

12. The method of claim 11, further comprising activating a conversion program on the second processor of the cluster.

13. The method of claim 12, further comprising the conversion program rendering state information of the old program as converted state information usable by the new program.
